(19) United States
(12) Patent Application Publication
(10) Pub. No.: US 2007/0132964 A1
(43) Pub. Date: Jun. 14, 2007

(54) Projection TV with Reduced Cabinent Dimensions

(75) Inventors: Dana F. Segler JR., Allen, TX (US); Steven M. Penn, Plano, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 11/164,864

(22) Filed: Dec. 8, 2005

(51) Int. Cl. G03B 21/22

(52) U.S. Cl. 353/78

(57) ABSTRACT

Described is a rear projection television with reduced cabinet depth and method of manufacturing thereof. An anamorphic projection lens compresses an image and projects it along an optic path, where a cylindrical mirror expands and reflects the image within the optic path. The combination of compression and expansion facilitates in the design of a rear projection television with reduced cabinet depth.

### TECHNICAL FIELD

Disclosed embodiments relate to televisions, and more particularly to a rear projection television with reduced cabinet depth and height.

### BACKGROUND

FIG. 1 illustrates a prior-art rear projection television 100 having a light engine 102 situated near the bottom of the TV 100 along with a projection lens 104. The light engine 102 may be refractive or reflective in nature and generally contains a light source, optical elements and lenses, and a spatial light modulator (such as a digital micromirror device (DMD)). The projection lens 104 may be integrated with the light engine 102. The features and functions of SLMs and DMDs are further described in a commonly owned U.S. Pat. No. 6,038,056 entitled “Spatial light modulator having improved contrast ratio,” filed Jul. 16, 1999, which is incorporated herein by reference in its entirety for all purposes.

An image may be generated by the light engine 102, focused by the projection lens 104, and projected onto a fold mirror 108 along a first optic axis 106. The projected image is expanded along the first optic axis 106 as it is being projected from the projection lens 104 onto the fold mirror 108. The fold mirror 108 may be curved or flat. The image is then reflected by the fold mirror 108 along a second optic axis 110, and onto a TV screen 112. As a result of the need to accommodate the light engine 102, the projection lens 104, and various optical components (not shown), as well as the length of the first and second optic axes 106, 110 within the projection TV 100, conventionally there exists a certain cabinet depth 114 of about 13 to 16 inches from the TV screen 112 to the back of the television set 100.

### SUMMARY

Described is a rear projection television with reduced cabinet depth and/or height and method of manufacturing thereof. An anamorphic projection lens compresses an image and projects it along a first optic path. A curved mirror then expands and reflects the image along a second optic path. The combination of compression and expansion facilitates in the design of a rear projection television with reduced cabinet depth and/or height.

### BRIEF DESCRIPTION OF THE DRAWINGS

FIG. 1 illustrates a cross-sectional view of a prior-art rear projection television;

FIG. 2 illustrates a cross-sectional view of a rear projection television according to the present disclosure; and

FIG. 3 illustrates a cross-sectional view of another embodiment of a rear projection television according to the present disclosure.

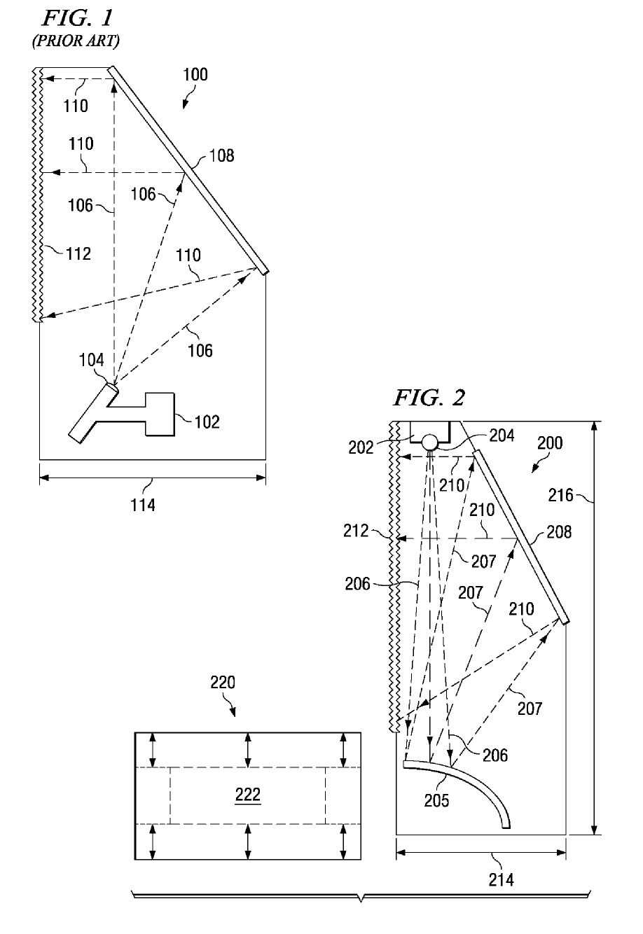

### DETAILED DESCRIPTION OF THE PREFERRED EMBODIMENTS

FIG. 2 illustrates a rear projection television 200 using the presently disclosed embodiments resulting in reduced cabinet depth 214 and/or reduced cabinet height 216. As illustrated, a light engine 202 may be situated at the top of the TV 200 along with a projection lens 204. The projection lens 204 may be integrated with the light engine 202. Although the light engine 202 typically involves a spatial light modulator (SLM) (such as a digital micromirror device (DMD)), the light engine 202 may also be for liquid crystal type projection televisions 200. The TV screen 212 may be a conventional rear projection screen.

An image 220 is initially generated by the light engine 202 and focused by the projection lens 204. The projection lens 204 is an anamorphic projection lens 204 that condenses or squeezes the image 222. An anamorphic projection lens 204 can optically distort the image 220 in one or more dimensions. The distortion or compression may be vertical, horizontal, or combinations thereof. Additionally, other anamorphic optical elements (not shown) may be used to reduce the size of the image 222. If the light engine 202 and the anamorphic projection lens 204 are integrated, then they can together operate to anamorphically project an image.

The compressed or distorted image 222 is then projected onto a curved mirror 205 along a first optic axis 206. Although the compression may distort the image 222, it preserves the resolution of the image 220. The curved mirror 205 may be a cylindrical mirror with reflective surfaces, shaped with power. Additionally, the curved mirror 205 may also be a non-planar mirror, a spherical mirror, or a mirror with a convex reflecting surface. Furthermore, the curved mirror 205 may be a cylindrical drum. In other embodiments, the mirrors 305 and 308 may be fresnel magnifiers or diffraction gratings, in which case the mirrors may be fabricated from planar substrates. The curved mirror 205, due to its convex curvature, will expand the compressed image 222 to reproduce the original image 220. In other words, the curved mirror 205 will return the compressed image 222 to its original size. The curved mirror 205 has similar anamorphic properties as that of the anamorphic projection lens 204. Furthermore, the curvature of the curved mirror 205 may be designed to match the curvature of the anamorphic projection lens 204. This configuration offers the ability to compress the depth of the projection TV cabinet. For example, in some embodiments, cabinet depths of twelve inches and less are enabled. Additionally, the height below the bottom of the screen, (also known as the chin height) may be reduced using this configuration.

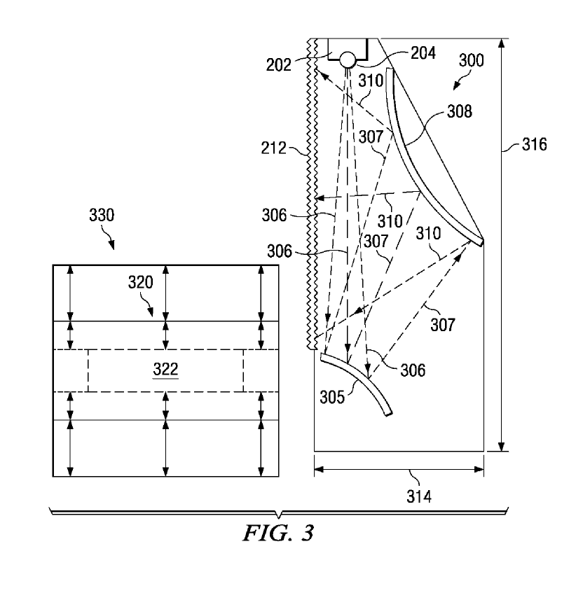

The re-established image 220 is then reflected from the curved mirror 205 onto a fold mirror 208 along a second optic axis 207. The fold mirror 208 may be curved or flat (a curved embodiment is shown with reference to FIG. 3). The fold mirror 208 will then take the restored image 220 and project it along a third optic axis 210, and subsequently onto a TV screen 212. Audiences can then view the restored image 220 projected on the TV screen 212.

FIG. 3 illustrates another embodiment of a rear projection television 300 in accordance with the present disclosure, resulting in reduced cabinet depth 314 and/or reduced cabinet height 316. As shown, a light engine 202 may be situated at the top of the TV 300 along with a projection lens 204. Rear projection TV 300 includes a first curved mirror 305 and a second curved mirror 308, situated as shown in the figure. The TV screen 212 may be a conventional rear projection screen.

The first curved mirror 305 in combination with the second curved mirror 308, due to the convex curvature (or equivalent thereof) of both mirrors, operate to expand the compressed image 322 to reproduce the original image 330. In other words, the first curved mirror 305 in combination with the second curved mirror 308 will return the compressed image 322 to its original size. The first curved mirror 305, in combination with the second curved mirror 308, has similar anamorphic properties as that of the anamorphic projection lens 204. Furthermore, the curvatures of the first curved mirror 305 and second curved mirror 308 may be designed to match the curvature of the anamorphic projection lens 204. This configuration offers the ability to further compress the height and depth of the projection TV cabinet. For example, in some embodiments, cabinet depths of twelve inches and less are enabled. Additionally, the height below the bottom of the screen, (also known as the chin height) may be further reduced using this configuration.

Illustrating the operation of TV 300, an image 330 is initially generated by the light engine 202 and focused by the projection lens 204. The projection lens 204 is an anamorphic projection lens 204 that condenses or squeezes the image 322. An anamorphic projection lens 204 can optically distort the image 330 in one or more dimensions. The distortion or compression may be vertical, horizontal, or combinations thereof. Additionally, other anamorphic optical elements (not shown) may be used to reduce the size of the image 322. If the light engine 202 and the anamorphic projection lens 204 are integrated, then they can together operate to anamorphically project an image.

The compressed or distorted image 322 is then projected onto a first curved mirror 305 along a first optic axis 306. Although the compression may distort the image 322, it preserves the resolution of the partially re-established image 320. The curved mirrors 305 and 308 may be a cylindrical mirrors with reflective surfaces. Additionally or alternatively, the curved mirrors 305 and 308 may be non-planar mirrors, spherical mirrors, mirrors with a convex reflecting surface, cylindrical drums, or a combination thereof. In other embodiments, the mirrors 305 and 308 may be fresnel magnifiers or diffraction gratings, in which case the mirrors may be fabricated from planar substrates.

The partially re-established image 320 is then reflected from the first curved mirror 305 onto a second curved mirror 308 along a second optic axis 207. As previously discussed, second curved mirror 308 may be curved or of a construction that provides similar power properties of a curved mirror. The second curved mirror 308 will then take the partially re-established image 320 and reflect it along a third optic axis 310, and subsequently onto a TV screen 212 to create restored image 330. Audiences can then view the restored image 330 projected on the TV screen 212.

It will be appreciated by those of ordinary skill in the art that the invention can be embodied in other specific forms without departing from the spirit or essential character thereof. For example, as a result of the distorting and recovering the image, there may also be a reduction in chin height, or the spacing between the bottom of the TV screen 212 and the bottom of the television set 200. In another example, the overall configuration may also be inverted such that the light engine 202 may be situated at the bottom of the cabinet. Other variations may include positioning the light engine at either side of the cabinet. The presently disclosed embodiments are therefore considered in all respects to be illustrative and not restrictive. The scope of the invention is indicated by the appended claims rather than the foregoing description, and all changes that come within the meaning and ranges of equivalents thereof are intended to be embraced therein.

Additionally, the section headings herein are provided for consistency with the suggestions under 37 C.F.R. § 1.77 or otherwise to provide organizational cues. These headings shall not limit or characterize the invention(s) set out in any claims that may issue from this disclosure. Specifically and by way of example, although the headings refer to a “Technical Field,” the claims should not be limited by the language chosen under this heading to describe the so-called technical field. Further, a description of a technology in the “Background” is not to be construed as an admission that technology is prior art to any invention(s) in this disclosure. Neither is the “Summary” to be considered as a characterization of the invention(s) set forth in the claims found herein. Furthermore, any reference in this disclosure to “invention” in the singular should not be used to argue that there is only a single point of novelty claimed in this disclosure. Multiple inventions may be set forth according to the limitations of the multiple claims associated with this disclosure, and the claims accordingly define the invention(s), and their equivalents, that are protected thereby. In all instances, the scope of the claims shall be considered on their own merits in light of the specification, but should not be constrained by the headings set forth herein.

What is claimed is:

1. A rear projection television, comprising:
a light engine operable to project an image;
a projection lens located at the exit of the light engine, the projection lens operable to condense the image along a first optic axis; and
a curved mirror located at the end of the first optic axis, the curved mirror operable to expand the image along a second optic axis; and
a fold mirror located at the end of the second optic axis, the fold mirror operable to reflect the image onto a screen.

2. The television according to claim 1, wherein the light engine and the projection lens are integrated.

3. The television according to claim 1, wherein the projection lens is an anamorphic projection lens.

4. The television according to claim 1, wherein the curved mirror is a cylindrical fold mirror.

5. The television according to claim 1, wherein the television has a cabinet depth of less than 12 inches.

6. The television according to claim 1, wherein the fold mirror is curved.

7. A method of rear projection, comprising:
projecting an image from a light engine;
condensing the image along a first optic axis with a projection lens, the projection lens being located at the exit of the light engine;
expanding the image along a second optic axis with a curved mirror, the curved mirror being located at the end of the first optic axis; and
reflecting the image onto a screen with a fold mirror, the fold mirror being located at the end of the second optic axis.

8. The method according to claim 7, wherein condensing the image along a first optic axis with a projection lens comprises the projection lens being an anamorphic projection lens.

9. The method according to claim 7, wherein expanding the image along a second optic axis with a curved mirror comprises the curved mirror being a cylindrical fold mirror.

10. The method according to claim 7, wherein the method of rear projection is operable to produce a television with a cabinet depth of less than 12 inches.

11. The method according to claim 7, wherein the method of reflecting the image onto a screen with a fold mirror comprises the fold mirror being curved.

12. A rear projection television, comprising:
a light engine operable to project an image;
an anamorphic lens located at the exit of the light engine, the anamorphic lens operable to distort the image along a first optic axis; and
a cylindrical curved mirror located at the end of the first optic axis, the cylindrical curved mirror operable to expand the image along a second optic axis; and
a fold mirror located at the end of the second optic axis, the fold mirror operable to reflect the image onto a screen.

13. The television according to claim 12, wherein the light engine and the anamorphic lens are integrated.

14. The television according to claim 12, wherein the television has a cabinet depth of less than 12 inches.

15. The television according to claim 12, wherein the fold mirror is curved.
